(19) United States
(12) Patent Application Publication
(10) Pub. No.: US 2019/0191491 A1
(43) Pub. Date: Jun. 20, 2019

(54) AIR FLAP APPARATUS HAVING AN AIR FLAP CONSTITUTED AT LEAST IN PORTIONS FROM ELECTRICALLY CONDUCTIVE PLASTIC FOR ELECTRICAL HEATING THEREOF

(71) Applicant: Röchling Automotive SE & Co. KG, Mannheim (DE)

(72) Inventors: Thomas Tsigkopoulos, Nürnberg (DE); Klaus Pfaffelhuber, Augsburg (DE)

(21) Appl. No.: 16/217,202

(22) Filed: Dec. 12, 2018

(30) Foreign Application Priority Data
Dec. 14, 2017 (DE) 10 2017 222 800.8

(51) Int. Cl. H05B 3/26; B60K 11/08

(52) U.S. Cl. CPC H05B 3/26; B60K 11/08

(57) ABSTRACT

An air flap apparatus for a motor vehicle encompasses an apparatus frame having a passthrough opening and having at least one air flap, received on the frame movably between an open position and a closed position, for modifying an air flowthrough-capable cross section of the passthrough opening, the flowthrough-capable cross section of the passthrough opening being larger when the at least one air flap is in the open position than when the at least one air flap is in the closed position, a selectably current-passage-capable electrical resistance heating apparatus, which encompasses a heating conductor and a current source, being provided in the at least one air flap, the current source being embodied to output to the heating conductor an electrical power level that is sufficient to heat it from an initial temperature of 20° C. by at least 2 K in 10 minutes, at least one heating portion of the at least one air flap is constituted from electrically conductive plastic, so that the air flap itself constitutes the heating conductor.

The present invention relates to an air flap apparatus for a motor vehicle. The air flap apparatus encompasses an apparatus frame having a passthrough opening and having at least one air flap, received on the frame movably between an open position and a closed position, for modifying the size of an air flowthrough-capable cross section of the passthrough opening. The flowthrough-capable cross section of the passthrough opening is larger when the at least one air flap is in the open position than when the at least one air flap is in the closed position. A selectably current-passage-capable electrical resistance heating apparatus, which encompasses a heating conductor and a current source, is provided in the at least one air flap. The current source is embodied to output to the heating conductor an electrical power level that is sufficient to heat it from an initial temperature of 20° C. by at least 2 K in 10 minutes.

### BACKGROUND OF THE INVENTION

An air flap apparatus of the species is known from DE 10 2012 023 067 A1. With this known air flap apparatus, an electrical heating apparatus (not further characterized), with which a movable air guidance element can be deiced as necessary, can be provided in the air guidance element that serves, for example, to control an air flow to an engine cooling unit.

DE 10 2006 054 423 A1 discloses an electrically heatable plastic film that comprises at least one electrical conductive layer, the electrical conductivity of the plastic layer being constituted by mixing electrically conductive additives into a plastic matrix. The known plastic film serves for the manufacture of planar heating films.

DE 10 2004 049 148 A1 discloses a heating film that is arranged on a side of a bumper which faces toward a vehicle body so that a radar reception/transmission device arranged in its vicinity can be heated if necessary, since the transmission and reception characteristics of radar units can be greatly modified by the particular prevailing weather conditions (temperature, humidity).

DE 10 2008 015 853 A1 discloses a heatable plastic window for motor vehicles. The teaching of this document is to print a heating conductor onto the plastic surface of the plastic window using the silk-screening method.

DE 10 2014 207 566 A1 discloses an air flap arrangement for motor vehicles whose air flaps can be constituted at least in portions from electrically conductive plastic material, so that an operating position of the air flap can be inferred depending on whether or not the electrically conductive air flap portion is in electrically conductive contact with a further component.

Air flap apparatuses on motor vehicles are usually in contact with ambient air and are therefore exposed to the ambient temperatures existing in the external environment of the respective motor vehicle. Those ambient temperatures can fluctuate in the course of a year by several dozen kelvin depending on the operating region of the motor vehicle; depending on the season and on the coefficient of thermal expansion of the material or materials used to constitute the air flap apparatus, this can result in undesired differences in the dimensions of a given air flap apparatus.

Regardless of the respective temperature differences occurring in the course of a year between a maximum and minimum temperature, the air flap apparatus can be immobilized by icing if the temperature falls below the freezing point, and can thus no longer perform its intended function of controlling or regulating a convectively cooling air flow to a heat exchanger of an internal combustion engine. To avoid this immobilization due to icing, the teaching of DE 10 2012 023 067 A1 of the species is to arrange an electrical heating apparatus in a movable air guidance element. The approach proposed by the document of the species is, however, complex and costly.

### SUMMARY OF THE INVENTION

An object of the present invention is therefore to propose an air flap apparatus that reliably makes possible, with a simpler structure, electrical heating of the air flap at least in portions.

This object is achieved according to the present invention by an air flap apparatus of the species in which at least one heating portion of the at least one air flap is constituted from electrically conductive plastic, so that the air flap itself constitutes the heating conductor. A heating portion of the air flap can thus already be defined upon manufacture of the air flap merely by material selection, with no need to embed separately embodied heating conductors for that purpose into a plastic material of the air flap, for example by placing a heating conductor arrangement into an injection molding cavity and injection-embedding it. Electrically heatable air flaps can thus be manufactured more economically, and in greater quantities per unit time, as compared with the existing art.

In a manner known per se, the at least one air flap projects into the passthrough opening and preferably passes through it, so that its flowthrough-capable cross section can be modified by a change in position.

An electrically conductive plastic can be furnished by introducing electrically conductive particles into a plastic matrix.

In case of doubt, a temperature rise of 2 K in 10 minutes due to passage of current from the current source is to be measured proceeding from a homogeneous initial temperature of 20° C. of the air flap apparatus in an air atmosphere at 1013 hPa, excluding any air flow flowing onto the air flap apparatus. Convective flows that form as a result of heating of the at least one heating portion are permissible.

As a rule, the at least one air flap comprises a flap leaf arranged in the passthrough opening, and at least one bearing configuration. The bearing configuration can then interact with a counterpart bearing configuration on the frame for movable support of the air flap on the frame, for example in the manner of a cylindrical or conical bearing shaft constituting the bearing configuration, which can be rotationally movably supported in a hollow-cylindrical or hollow-conical bushing constituting the counterpart bearing configuration. Because the flap leaf as a rule is to a greater extent exposed to environmental influences, in particular has wind blast flowing onto it during driving operation of the vehicle carrying the air flap apparatus and is therefore convectively cooled, the heating portion is preferably constituted at least on the flap leaf. An air flap of this kind, which in portions is electrically heatable and in portions not, can be manufactured using two-component injection molding methods by the fact that a first portion is generated from a first electrically nonconductive plastic material, and a second portion from an electrically conductive plastic material.

Since the purpose of introducing heat electrically into the air flap is, specifically in the case where deicing is desired, principally to melt ice that is wetting the surface of the air flap, in particular of the flap leaf, it is advantageous if the heating portion extends at least along a surface portion of the air flap, in particular of the flap leaf. A flap core located below the surface of the air flap can be embodied to be electrically nonconductive. In the context of a correspondingly electrically conductively embodied surface layer that surrounds this flap core, the latter can be heated by thermal conduction inward from the surface layer.

In order to allow the air flap arrangement to be deiced as quickly as possible, according to a preferred refinement of the present invention provision is made that at least the entire surface of the flap leaf is constituted from electrically conductive plastic. The surface of the entire flap leaf can thereby be heated in a single heating operation even though only a portion of the flap leaf, namely a portion constituting its outer surface, is constituted from electrically conductive plastic, while the flap core is not. To avoid a more complex two-component injection molding method, the entire flap leaf can be embodied as a heating portion.

For the introduction or conveyance of electrical energy from the current source to the at least one heating portion of the at least one air flap, at least one surface of a bearing configuration can be constituted from electrically conductive plastic. That surface can be electrically conductively connected to a surface, constituted from electrically conductive plastic, of the flap leaf.

The surface of the bearing configuration, which is preferably a bearing configuration that is rotationally symmetrical with reference to a rotation axis around which the at least one air flap is displaceable between its two operating positions (open position and closed position), can be a wiper contact. The latter can be embodied from metal, separately from the remainder of the bearing configuration embodied from plastic, for example as a slip ring. Another option is to integrate into the bearing configuration a preferably likewise rotationally symmetrical contact component, and to allow the contact component to protrude axially beyond the region that acts mechanically as a motion bearing. Rotationally symmetrical contact components are already known in audio technology in the form of RCA connectors.

The bearing configuration can also be constituted in portions, or preferably entirely, from electrically conductive plastic, so that the at least one air flap is manufacturable preferably integrally in a single injection molding operation. The at least one bearing configuration and the flap leaf are therefore preferably constituted from the electrically conductive plastic.

In order to allow electrical energy to be conveyed through portions of the air flap without causing them to be appreciably heated as a result, or in order to keep their heating limited as compared with other portions, the at least one air flap can comprise at least two portions, each constituted from electrically conductive plastic, having different electrical resistance values. Upon the passage of electrical energy, that portion which has the higher electrical resistance value will then experience greater heating than a portion having a lower electrical resistance. It is thereby possible on the one hand to embody portions that heat up differently upon passage of a uniform current through the at least one air flap. On the other hand, electrical current can be introduced through a bearing configuration without causing it to jam, together with its counterpart bearing configuration, as a result of thermal expansion, since its electrical resistance can be selected to be lower than the electrical resistance of a portion in the flap leaf.

For targeted warming and heating of the at least one air flap as necessary, the air flap apparatus can comprise a control apparatus that applies control to the current source in order to pass current through the heating conductor. The control apparatus can be connected in signal-transferring fashion to at least one sensing device from among a flap temperature sensor for sensing an air flap temperature, an ambient temperature sensor for sensing an ambient temperature, a flap position sensing device for sensing at least one operating position of the at least one air flap, and a fit accuracy sensing device for sensing a dimensional accuracy or fit accuracy of the at least one air flap, and consequently can be embodied to activate the current source in accordance with at least one sensed signal of at least one sensing device.

For example, the control apparatus can be embodied to pass current through, and consequently to heat, the at least one air flap when sensed signals of corresponding sensing devices indicate that the ambient temperature is below a predetermined ambient temperature threshold value and/or that the flap temperature is below a predetermined flap temperature threshold value.

The aforementioned fit accuracy sensing device is of noteworthy importance. Depending on the particular ambient temperatures that exist, the at least one air flap can have different dimensions as a result of thermal expansion. Undesired leakages in the air flap apparatus can occur as a result when the air flap becomes too cold. Such leakages can be identified, for example, by firstly identifying the operating position of the at least one air flap and, when the operating position is a predetermined operating position, for example the closed position, identifying whether an electrical contact exists between a portion of the at least one air flap and an adjacent portion, for example as is known in principle from the aforementioned DE 10 2014 207 566 A1. If the electrical contact does not exist even though it should be present in the identified operating position, the control apparatus applies control to the current source in order to pass current through the heating portion until electrical contact has been sensed.

Alternatively, the control apparatus can apply control to the current source in such a way that the temperature of the at least one air flap is in a predetermined temperature range for which it is known that in that temperature range, predetermined actual dimensions of the at least one air flap differ from their nominal dimensions by no more than a predetermined permitted tolerance.

The present invention has been described above always with reference to an air flap apparatus having at least one air flap. To allow the widest possible variability of the convective cooling of apparatuses located behind the passthrough opening in a flowthrough direction, the air flap apparatus preferably comprises a plurality of air flaps, each of which comprises at least one heating portion that is constituted from electrically conductive plastic. In order to facilitate manufacturability thereof, preferably several of, particularly preferably all, the air flaps of an air flap apparatus are embodied identically in terms of their electrically conductive portions.

The present invention furthermore relates to a use of an air flap apparatus, in particular an air flap apparatus as described and refined above, having an air flap which is supported movably in an apparatus frame and of which at least a current-passage-capable heating portion is constituted from electrically conductive plastic, to heat at least the heating portion. The heating can serve for deicing and/or to achieve a thermally induced dimensional change at least in the heating portion.

Lastly, the present invention also relates to a motor vehicle having an air flap apparatus as described and refined above.

These and other objects, aspects, features and advantages of the invention will become apparent to those skilled in the art upon a reading of the Detailed Description of the invention set forth below taken together with the drawing which will be described in the next section.

### BRIEF DESCRIPTION OF THE DRAWING

The invention may take physical form in certain parts and arrangement of parts, a preferred embodiment of which will be described in detail and illustrated in the accompanying drawing which form a part hereof and wherein:

FIG. 1 is a schematic rear view of an embodiment according to the present invention of an air flap apparatus of the present Application;

FIG. 2 shows an alternatively configured air flap for use in an air flap apparatus according to the present invention; and

FIG. 3 is a schematic side view of a vehicle having the air flap apparatus of FIG. 1 with iced-up air flaps.

### DESCRIPTION OF PREFERRED EMBODIMENTS

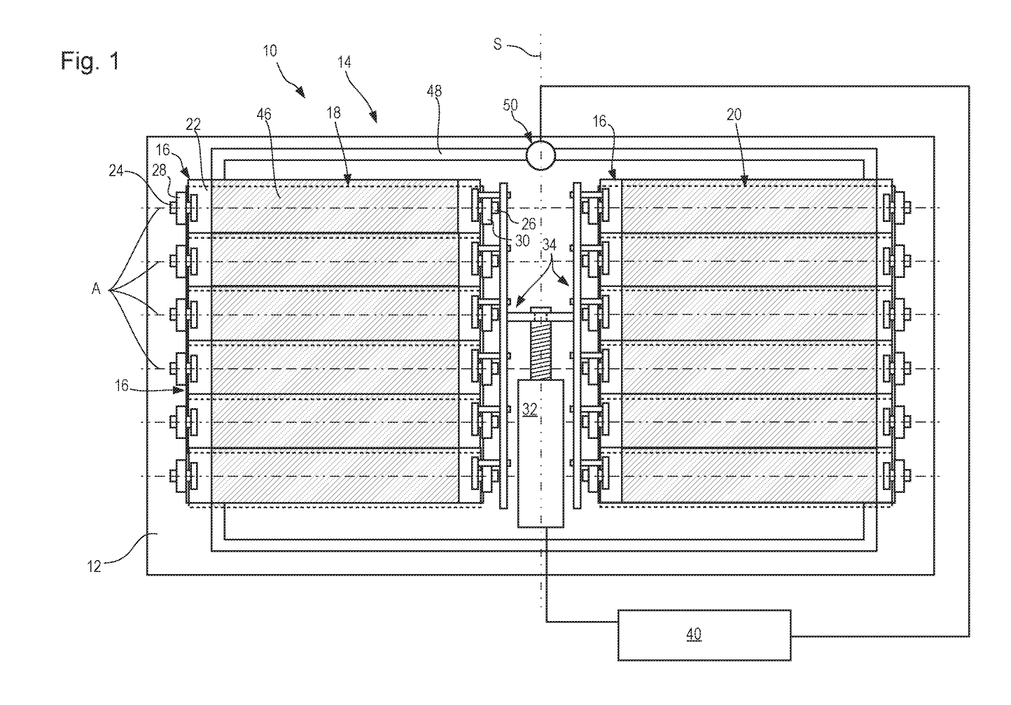

Referring now to the drawing wherein the showings are for the purpose of illustrating preferred and alternative embodiments of the invention only and not for the purpose of limiting the same, FIG. 1 shows an embodiment according to the present invention of an air flap apparatus of the present Application, depicted in a schematic rear view, that is designated generally as 10. Air flap apparatus 10 encompasses an apparatus frame 12 that defines a passthrough opening 14 and that movably supports a plurality of air flaps 16. Passthrough opening 14 is divided into two partial passthrough openings 18 and 20 through each of which air flaps 16 pass.

Air flaps 16 of left partial passthrough opening 18 and of right partial passthrough opening 20 are embodied mirror-symmetrically with reference to a mirror symmetry plane S that is orthogonal to the drawing plane of FIG. 1 and is located equidistantly from the two partial passthrough openings 18 and 20. Given the mirror symmetry, it is therefore sufficient to describe only one air flap 16, the description of which is applicable to all air flaps 16 shown in FIG. 1.

Air flaps 16 are each movable around mutually parallel pivot axes A between their closed position depicted in FIG. 1, in which partial passthrough openings 18 and 20 are closed off by air flaps or air is more greatly impeded from flowing through, and an open position in which partial passthrough openings 18 and 20 are open or through-flow by air in a direction orthogonally to the drawing plane is less greatly impeded.

Each air flap 16 comprises a flap leaf 22 that is located in passthrough opening 14 and that effects blockage and clearance of the passthrough opening for flow. Each air flap 16 furthermore comprises two bearing configurations 24 and 26 that protrude in the form of stub shafts in opposite directions from flap leaf 22 on either side thereof. Bearing configurations 24 and 26 support flap leaf 22, and consequently air flap 16 as a whole, for rotation around pivot axis A associated with the respective air flap 16, and are therefore arranged coaxially with pivot axis A.

The term “flap leaf” is not to be construed obligatorily to mean only a planar conformation thereof, although the latter is preferred for reasons of low flap weight. The flap leaf can also be embodied as a solid, for example as a prism-like solid.

Bearing configurations 24 and 26 are supported rotatably on apparatus frame 12 in respectively associated counterpart bearing configurations 28 and 30, for example in the form of bearing bushings.

A motion drive system 32, depicted by way of example in the form of a spindle drive, is coupled in movement-transferring fashion to air flaps 16 via a linkage 34 in a manner known per se, in such a way that air flaps 16 are collectively pivotable between their operating positions by way of a single motion drive system 32.

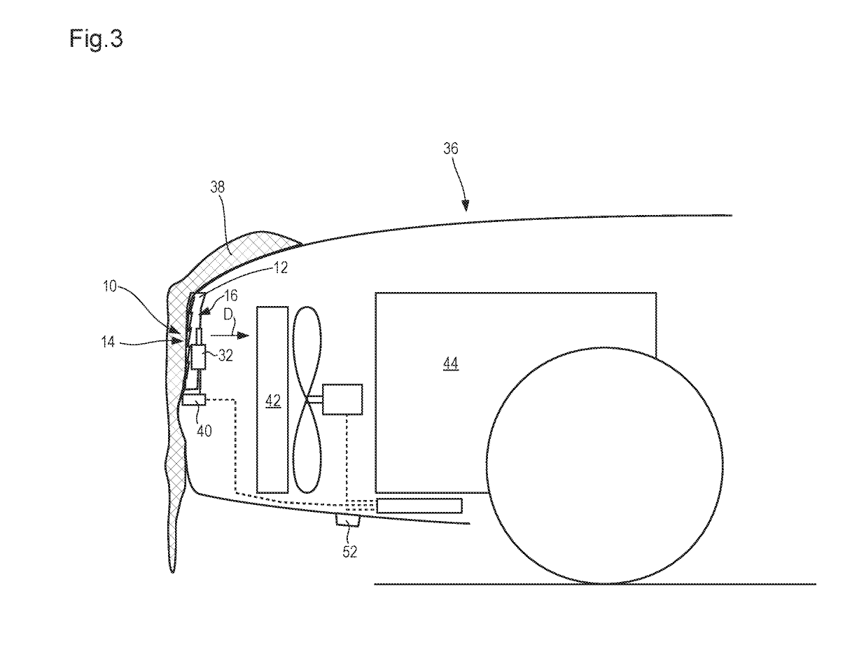

As indicated by the schematic side view of FIG. 3, air flap apparatus 10 can ice up, for example, if a vehicle 36 carrying air flap apparatus 10 is parked outdoors and the outside temperature falls below the freezing point after precipitation. Moisture deposited on vehicle 36 can then freeze. FIG. 3 depicts an ice cap 38 (exaggerated for explanatory purposes) that has formed on a vehicle front end and constitutes an undesired physical barrier against displacement of air flaps 16 between their operating positions. Because air flaps 16 are often brought into the closed position by the vehicle control system, or by a control apparatus 40 of air flap apparatus 10, when the vehicle is shut off, air flaps 16 are in the closed position in the situation shown in FIG. 3 (and in that of FIG. 1).

In the icing situation shown in FIG. 3, functional components located behind passthrough opening 14 in apparatus frame 12 in flowthrough direction D, for example a radiator heat exchanger 42 and/or an internal combustion engine 44, are not reachable for a long period of time by an air flow for convective cooling.

For deicing purposes it is already known to equip air flaps of an air flap apparatus with an electrical resistance heating apparatus so that the temperature of the air flaps can be elevated as applicable by activating the heating apparatus.

In the present case, on air flaps 16 of FIG. 1 a central portion of flap leaves 22 is manufactured from an electrically conductive plastic, so that heating portion 46 thereby constituted (cross-hatched in FIG. 1) has a specific volume resistance of between 10² and 10⁴ Ωmm²/m. This resistance value is recited merely by way of example. It can also deviate from the range recited. As a result of the electrical conductivity of heating portion 46 thereby established, heating portion 46 can be heated upon corresponding current passage as a result of its electrical resistance. Heating portion 46, however, constituting an electrically conductive portion, has a specific volume resistance of less than 10¹¹ Ωmm²/m—a value that is typical of unfilled plastic and is to be regarded as electrically insulating, i.e. not conductive.

For current passage through heating portion 46, in the exemplifying embodiment of FIG. 1 there is provided on apparatus frame 12 an electrical conductor 48 that, when air flaps 16 are in their closed position, forms a closed electrical circuit together with air flaps 16. A current source 50 depicted schematically and merely by way of example, which as a rule comprises a combination of a vehicle battery with a switching device, is switchable by control apparatus 40 of air flap apparatus 10.

Control apparatus 40 can be coupled, for example, to an ambient temperature sensor 52 (see FIG. 3) and, as a function of the latter's sensed signal, can switch current source 50 on or off for current passage. Control apparatus 40 can also sense the current flowing in motion drive system 32 and, on the basis of that sensed current value in combination with the signal of ambient temperature sensor 52, can infer a blockage of air flaps 16 due to icing and can cause deicing of air flaps 16 by passage of current through heating portions 46.

Heating portion 46 of an air flap 16 can be implemented, for example, using a graphite-filled polypropylene that is obtainable on the market under the commercial name “TECACOMP® PP HTE black 4098.” Other electrically conductive materials that are processable by injection molding can also be used to manufacture heating portion 46.

When correspondingly switched by control apparatus 40, current source 50 feeds into air flaps 16 an electrical power level that, under otherwise constant conditions, raises their temperature by at least 2 K in 10 minutes starting from an initial temperature of 20° C. (i.e. without icing). The temperature rise will in fact turn out to be greater than 2 K under the conditions recited. The sensorial use, already known from the existing art, of electrically conductively embodied plastic portions of air flaps utilizes the electrical conductivity of those plastic portions to detect one or more operating positions of the air flaps. The currents flowing through the electrically conductively embodied plastic portions of air flaps in the context of sensorial utilization are, however, so low that while they serve to recognize electrical contact situations and electrical resistance values, they do not result in an elevation of the temperature of the electrically conductive plastic portions.

Electrical heating of air flaps 16 of air flap apparatus 10 of FIG. 1 functions, however, only in their closed position, in which the electrical circuit through the current-carrying conductors 48 is in fact closed by air flaps 16.

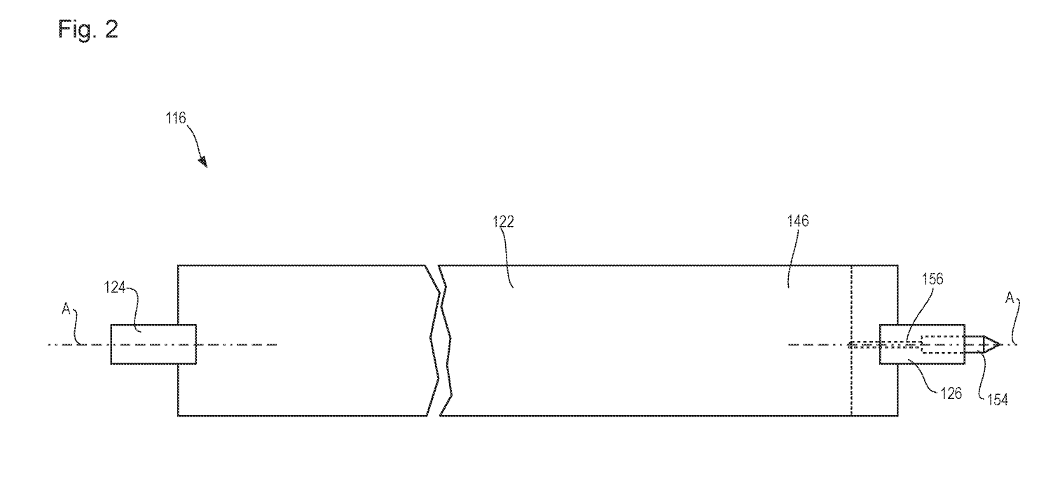

With the alternative air flap 116 shown in FIG. 2, heating of air flap 116 is possible regardless of its operating position.

Components or component portions that are identical and functionally identical to those in FIG. 1 are labeled in FIG. 2 with the same reference characters but incremented by 100. The alternative embodiment of an air flap 116 is explained below only insofar as that embodiment differs from air flaps 16 of FIG. 1, to the description of which the reader is otherwise also expressly referred for an explanation of air flap 116.

The left side of air flap 116 indicates that the entire flap leaf 122, and also bearing configuration 124, can be manufactured from electrically conductive plastic by injection molding. Current can then be introduced, via the likewise electrically conductive bearing configuration 124, into flap leaf 122 that is particularly affected by low ambient temperature. The counterpart bearing configurations, embodied as bearing bushings, can then comprise a wiper contact that continuously contacts bearing configuration 124. Bearing configuration 124 can furthermore be manufactured from a plastic that has a greater degree of filling with electrically conductive particles than flap leaf 122, so that bearing configuration 124 heats up less than flap leaf 122 upon current passage.

It is indicated on the right side of air flap 116 of FIG. 2 that for current passage through heating portion 146, a metallic contact pin 154 can be integrated into bearing configuration 126, for example by injection or overmolding of contact pin 154 with injection-molded material of bearing configuration 126. Contact pin 154 is preferably embodied rotationally symmetrically at least at its contact portion protruding axially beyond bearing configuration 126, so that it can be continuously in electrically conductive contact with a frame-mounted supply bushing regardless of the operating position of air flap 116, so that current can be conveyed to heating portion 146 through the supply bushing and through contact pin 154. Conduction from contact pin 154 to heating portion 146 can be accomplished via a conductor arrangement 156 likewise embedded into the plastic material of air flap 116 or, with a corresponding electrically conductive embodiment of flap leaf 122 and of bearing configuration 126, can be accomplished through the plastic material of bearing configuration 126 and of at least a portion of flap leaf 122.

The right and left sides of air flap 116 can each be configured identically. Merely for the sake of simplicity, FIG. 2 shows differently configured bearing configurations, once using the example of bearing configuration 124 and again using the example of bearing configuration 126.

When air flap 116 is used, the embodiment of electrically conducting portions on bearing configurations 124 and 126 means that current can be introduced into the respective air flap 116 regardless of its operating state, and can consequently electrically heat air flap 116.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-10. (canceled)

11. An air flap apparatus for a motor vehicle, the air flap apparatus including an apparatus frame having a passthrough opening and having at least one air flap, received on the apparatus frame movably between an open position and a closed position, for modifying an air flowthrough-capable cross section of the passthrough opening, a flowthrough-capable cross section of the passthrough opening being larger when the at least one air flap is in the open position than when the at least one air flap is in the closed position, a selectably current-passage-capable electrical resistance heating apparatus, which includes a heating conductor and a current source, being provided in the at least one air flap, the current source being configured to output to the heating conductor an electrical power level that is sufficient to heat the at least one air flap from an initial temperature of 20° C. by at least 2 K in 10 minutes,
wherein at least one heating portion of the at least one air flap is constituted from electrically conductive plastic, so that the at least one air flap itself constitutes the heating conductor.

12. The air flap apparatus according to claim 11, wherein the at least one air flap comprises a flap leaf arranged in the passthrough opening and at least one bearing configuration that interacts with a counterpart bearing configuration on the apparatus frame for movable support of the at least one air flap on the apparatus frame, the at least one heating portion being embodied on the flap leaf.

13. The air flap apparatus according to claim 12, wherein the flap leaf has a flap leaf surface, the flap leaf surface of the flap leaf is constituted from the electrically conductive plastic as the at least one heating portion.

14. The air flap apparatus according to claim 12, wherein the entire flap leaf is constituted from the electrically conductive plastic as the at least one heating portion.

15. The air flap apparatus according to claim 13, wherein at least one bearing surface of the at least one bearing configuration is constituted from the electrically conductive plastic, and that the at least one bearing surface is electrically conductively connected to the flap leaf surface.

16. The air flap apparatus according to claim 11, wherein the at least one air flap comprises at least two portions, each constituted from electrically conductive plastic, having different electrical resistance values.

17. The air flap apparatus according to claim 11, further including a control apparatus that applies control to the current source in order to pass current through the heating conductor, the control apparatus being connected in signal-transferring fashion to at least one sensing device, the at least one sensing device including at least one of a flap temperature sensor for sensing an air flap temperature, an ambient temperature sensor for sensing an ambient temperature, a flap position sensing device for sensing at least one operating position of the at least one air flap , and a fit accuracy sensing device for sensing a dimensional accuracy or fit accuracy of the at least one air flap, the at least one sensing device is embodied to activate the current source in accordance with at least one sensed signal of the at least one sensing device.

18. The air flap apparatus according to claim 11, wherein the at least one air flap is a plurality of air flaps, each of the plurality of air flaps comprises the at least one heating portion that is constituted from electrically conductive plastic.

19. Use of an air flap apparatus, in particular an air flap apparatus according to claim 11, having the at least one air flap which is supported movably in the apparatus frame and of which at least a current-passage-capable heating portion is constituted from electrically conductive plastic, to heat at least the at least one heating portion.

20. Use of the air flap apparatus according to claim 11 for deicing of the at least one air flap.

21. Use of the air flap apparatus according to claim 11 to achieve a thermally induced dimensional change at least in the at least one heating portion.
